(19) United States
(12) Patent Application Publication
(10) Pub. No.: US 2023/0407700 A1
(43) Pub. Date: Dec. 21, 2023

(54) IN-BUILDING ACCESS PATH INSTALLATION TYPE SMOKE CONTROL SYSTEM

(71) Applicant: KIM Jung Gyu, Seoul (KR)

(72) Inventor: Sung Woo KIM, Osan-si (KR)

(73) Assignee: Jung Gyu KIM, Seoul (KR)

(21) Appl. No.: 18/034,727

(22) PCT Filed: Nov. 2, 2021
(86) PCT No.: PCT/KR2021/015725

§ 371 Date: May 1, 2023

(30) Foreign Application Priority Data
Nov. 2, 2020 (KR) 10-2020-0144430
Nov. 2, 2021 (KR) 10-2021-0148773

(51) Int. Cl. E06B 5/16; A62C 2/08; A62C 31/03; A62C 99/00

(52) U.S. Cl. CPC E06B 5/16; A62C 2/08; A62C 31/03; A62C 99/0072

(57) ABSTRACT

The present invention relates to an in-building access path installation type smoke control system. An in-building access path installation type smoke control system is openably and closably installed in an in-building access path and includes a door casing having an intake port and a discharge port, a door nozzle installed in the door casing and configured to spray water supplied from the outside, and a main door body including a negative pressure inducer configured to allow water sprayed from the door nozzle to pass therethrough, generate negative pressure on the basis of the Venturi effect while the water passes therethrough, suck gas at the periphery of the door casing through the intake port, mix the sucked gas with water, and move the gas mixed with the water downward toward the discharge port.

### TECHNICAL FIELD

The present invention relates to a smoke control system installed in various entrances or exits in a building, and more particularly, to an in-building access path installation type smoke control system that may quickly suck smoke and toxic gas produced in the event of a fire, mix the smoke and toxic gas with water, and remove the smoke and toxic gas mixed with the water, thereby preventing diffusion of smoke to minimize human casualties, providing emergency lighting, and generating anions to efficiently remove dust.

### BACKGROUND ART

Various firefighting facilities are mandatorily installed in most of buildings built recently, and the firefighting facilities meet criteria prescribed in the enhanced building firefighting law. These firefighting facilities include fire extinguishing facilities, smoke discharge facilities, smoke removal (control) facilities, alarm facilities, evacuation facilities, firefighting water facilities, and facilities related to fire extinguishing processes.

The basic purpose of the firefighting facility is, of course, to minimize damage to lives and property due to fires by detecting a fire early, protecting or evacuating people in the building, and enabling the people to extinguishing the fire at the initial time of the fire.

Among the several facilities, the smoke removal (control) facility is a type of firefighting facility. The smoke removal (control) facility detects smoke or the like produced at the initial time of a fire in a building, discharges the smoke in the fire room (living room), prevents smoke from spreading to hallways, stairs, and the like that are evacuation pathway, thereby protecting residents from smoke and allowing the residents to be evacuated safely. Further, the smoke removal (control) facility controls smoke and discharges smoke to the outside (fire smoke ventilation) to enable firefighters to extinguish the fire.

In case of the human casualties caused by a fire, a larger amount of asphyxiation occurs because of smoke (toxic gas and soot) diffused in a building by a fire gas flow rather than because of a direct influence of fire heat. The reason why toxic smoke produced in the event of a fire is fatal is that a diffusion speed of the toxic smoke is very high.

The toxic gas produced in the event of a fire prevents delivery of oxygen in blood and performs a fatal action that kills a person within a few minutes when the person inhales the toxic gas. The toxic gas contains a large amount of deadly poisonous component such as carbon monoxide (CO), hydrogen chloride (HCL), and hydrogen cyanide (HCN) and causes spasm, shock, respiratory damage, shortness of breath, stun, dizziness, respiratory paralysis, inability to behave, hemoptysis, excessive coughing, pulmonary edema, heart attack, mental confusion, corneal blisters, increase in body temperature, and the like. Accordingly, it is important to quickly remove smoke to minimize human casualties in the event of a fire.

Meanwhile, an in-building fire door serves to prevent diffusion of fire and delay ignition and is installed in an entrance or exit in the building. For example, in case that spaces are separated by wall bodies in the building, the fire doors are installed in the entrance or exit through which persons enter or exit the spaces.

The fire door is made of a non-combustible material. However, the fire door is continuously heat as long as the fire is completely extinguished. As a result, the fire door is deformed or cracked by heat and loses a fireproof function at any point in time. In addition, since the fire door is heated to a high temperature by flames, the person may get burned only when the person touches the fire door. In case that a flammable substance is present in the vicinity of the fire door, the flammable substance is sometimes ignited by receiving heat from the fire door.

There is a need for a technology to reduce a concentration of an indoor toxic substance to the extent that the person may at least breathe by efficiently removing toxic gas produced in the event of a fire and to maintain the function of the fire door by cooling the fire door so that the fire door does not lose the function thereof.

### DISCLOSURE

### Technical Problem

The present invention has been made in an effort to solve the above-mentioned problem, and an object of the present invention is to provide an in-building access path installation type smoke control system that may significantly reduce a concentration of smoke and toxic gas in the event of a fire, ensure a visual range, and minimize human casualties by guiding rapid evacuation by providing lighting even in the event of power outage.

Another object of the present invention is to provide an in-building access path installation type smoke control system that may prevent thermal deformation of or damage to a fire door and a fire shutter caused by flames by cooling the fire door and the fire shutter, thereby stably preventing diffusion of fire, and properly maintaining a fireproof function such as a function of ensuring as much evacuation time as possible.

### Technical Solution

As a technical solution for achieving the above-mentioned object, an in-building access path installation type smoke control system according to the present invention is openably and closably installed in an in-building access path and includes: a door casing having an intake port and a discharge port; a door nozzle installed in the door casing and configured to spray water supplied from the outside; and a main door body including a negative pressure inducer configured to allow water sprayed from the door nozzle to pass therethrough, generate negative pressure on the basis of the Venturi effect while the water passes therethrough, suck gas at the periphery of the door casing through the intake port, mix the sucked gas with water, and move the gas mixed with the water downward toward the discharge port.

In addition, as a technical solution for achieving the above-mentioned object, an in-building access path installation type smoke control system according to the present invention is fixed in an in-building access path and supports an entrance/exit door so that the entrance/exit door is openable and closable, the in-building access path installation type smoke control system including: a frame casing having an intake port and a discharge port; a frame nozzle installed in the frame casing and configured to spray water supplied from the outside; and a door frame having a negative pressure inducer configured to allow water sprayed from the frame nozzle to pass therethrough, generate negative pressure on the basis of the Venturi effect while the water passes therethrough, suck gas at the periphery of the frame casing through the intake port, mix the sucked gas with water, and move the gas mixed with the water downward toward the discharge port.

Further, the entrance/exit door may include: a door casing having an intake port and a discharge port; a door nozzle embedded in the door casing and configured to spray water supplied from the outside; and a main door body having a Venturi body configured to allow water sprayed from the door nozzle to pass therethrough, generate negative pressure on the basis of the Venturi effect while the water passes therethrough, suck gas at the periphery of the door casing through the intake port, mix the sucked gas with water, and move the gas mixed with the water downward toward the discharge port.

In addition, the main door body and the door frame may have a first sealing seal and a second sealing seal that operate in conjunction with each other, in a state in which the main door body is closed, to provide a route through which the water is supplied to the door nozzle.

Further, the door casing and the frame casing may respectively have first and second installation holes in which the first and second sealing seals are installed, the first sealing seal may include: a fixing ring having a ring shape and fitted into the first seal installation hole; and elastic blocking pieces integrated with an inner peripheral surface of the fixing ring and configured to be on standby in a closed state at ordinary times and spread and opened by hydraulic pressure when the hydraulic pressure is applied, and the second sealing seal may include: a fixing ring having a ring shape and fitted into the second seal installation hole; and elastic blocking pieces integrated with an inner peripheral surface of the fixing ring and configured to be on standby in a closed state at ordinary times and spread and opened by hydraulic pressure when the hydraulic pressure is applied.

In addition, as a technical solution for achieving the above-mentioned object, an in-building access path installation type smoke control system according to the present invention includes: a main door body including a door casing having an intake port and a discharge port and having a plurality of through receiving holes provided at an upper end thereof, and a negative pressure inducer installed in the door casing and configured to allow water discharged downward through the receiving hole to pass therethrough, generate negative pressure on the basis of the Venturi effect, suck gas at the periphery of the door casing through the intake port, mix the sucked gas with water, and guide the gas mixed with the water to the discharge port; and a door frame configured to support the main door body so that the main door body is openable and closable, the door frame including a frame casing having an intake port and a discharge port and having a discharge passage corresponding to the receiving hole in a one-to-one manner in a state in which the main door body is closed, and a nozzle installed in the frame casing and configured to spray water, which is supplied from the outside, to the discharge passage so that the water passes through the negative pressure inducer via the receiving hole.

In addition, sealing caps may be respectively mounted in the receiving hole and the discharge passage and separated and removed by receiving pressure of the water when the water is sprayed.

Further, as a technical solution for achieving the above-mentioned object, an in-building access path installation type smoke control system according to the present invention includes: a mixing housing installed at an upper side of a fire shutter in an in-building access path and having an intake port and a discharge port; a plurality of nozzles embedded in the mixing housing and configured to spray water supplied from the outside; and a negative pressure inducer installed below the nozzle and configured to allow water sprayed from the nozzle to pass therethrough, generate negative pressure on the basis of the Venturi effect while the water passes therethrough, suck gas at the periphery of the mixing housing through the intake port, mix the sucked gas with water, and discharge the gas mixed with the water.

In addition, the negative pressure inducer may include: a spray passage having an inner diameter that increases in a flow direction of water; and a plurality of intake passages opened in a lateral direction of the spray passage and allow the negative pressure generated in the spray passage to be applied to the outside.

The in-building access path installation type smoke control system may further include: a mixing spacer installed in the door casing and configured to mix water with gas while colliding with the sprayed water.

The in-building access path installation type smoke control system may further include: a small hydraulic power generator configured to produce electric power by receiving kinetic energy of water supplied in the event of a fire; an emergency lighting part configured to operate by receiving electric power of the small hydraulic power generator; and an anion generator configured to trap and remove positively charged particles in the gas by outputting anions.

### Advantageous Effects

The in-building access path installation type smoke control system of the present invention configured as described above may generate negative pressure in the event of a fire, suck ambient smoke and toxic gas, mix the smoke and toxic gas with water, and discharge the smoke and toxic gas mixed with the water, thereby significantly reducing a concentration of smoke and toxic gas, ensuring a visual range, providing lighting even in the event of power outage to guide quick evacuation and minimize human casualties.

In addition, the system may cool a fire door and a fire shutter to prevent thermal deformation of or damage to the fire door and the fire shutter caused by flames, thereby properly maintaining a fireproof function such as a function of preventing diffusion of a fire and a function of ensuring as much evacuation time as possible.

In particular, in case that the access path is applied to a toilet in a building, heat or gas cannot enter the toilet. In addition, in case that a ventilation fan is switched to an air supply fan, the toilet may be used as an emergency evacuation space.

### DESCRIPTION OF DRAWINGS

FIG. 1A is a block diagram illustrating an entire configuration of an in-building access path installation type smoke control system according to the present invention.

FIG. 1B is a view for explaining one usage example of the in-building access path installation type smoke control system according to the present invention.

FIGS. 2A and 2B are perspective views illustrating an external configuration of a fire door of an in-building access path installation type smoke control system according to a first embodiment of the present invention.

FIGS. 3A and 3B are exploded perspective views of a main door body illustrated in FIGS. 2A and 2B.

FIGS. 4A and 4B are cross-sectional side views illustrating the main door body illustrated in FIGS. 2A and 2B.

FIG. 5 is a cross-sectional side view illustrating a modified example of the main door body in FIG. 2A.

FIGS. 6 to 11 are side views schematically illustrating configurations of various negative pressure inducers applicable to the main door body in FIG. 2.

FIG. 12 is a view illustrating a modified example of the fire door applied to the in-building access path installation type smoke control system according to the first embodiment of the present invention.

FIGS. 13A to 13C is a view for explaining operations of a stationary sealing seal and a movable sealing seal illustrated in FIG. 12.

FIG. 14 is a view illustrating another modified example of the fire door of the in-building access path installation type smoke control system according to the first embodiment of the present invention.

FIG. 15 is a perspective view illustrating an external appearance of an in-building access path installation type smoke control system according to a second embodiment of the present invention.

FIG. 16 is a view schematically illustrating an internal configuration of a casing illustrated in FIG. 15.

FIG. 17 is a cross-sectional view illustrating an internal structure of a multistage negative pressure inducer in FIG. 16.

FIG. 18 is a view illustrating a modified example of the in-building access path installation type smoke control system according to the second embodiment of the present invention.

### BEST MODE

Hereinafter, one embodiment according to the present invention will be described in more detail with reference to the accompanying drawings.

An in-building access path installation type smoke control system of the present invention is applied to a fire door or a fire shutter installed in an in-building access path. That is, the fire door has a smoke control ability, such that the fire door quickly sucks smoke and toxic gas produced in the event of a fire, mixes the smoke and toxic gas with water, and discharges the smoke and toxic gas mixed with the water. Further, the fire door serves to allow the fire door or the fire shutter to stably perform the functions thereof by preventing the fire door or the fire shutter from being deformed and heated by a temperature of flames.

The ‘in-building access path’ in the present description means a passage in which a door or a shutter through which a person may pass is installed.

The smoke and toxic gas produced in the event of a fire are sucked by negative pressure applied on the basis of the Venturi principle, mixed with water, and removed. Because the fire door has the smoke control ability as described above, the fire door may minimize human casualties by preventing diffusion of smoke into a preset smoke removal zone, a fire room (living room), a hallway, a stair, and the like that are escape routes.

Among the high-temperature smoke and toxic gas produced in the event of a fire, gaseous and liquid particulate-based toxic gases are removed by being dissolved and diluted in water and cooled, and solid particulate-based soot and ultra-fine dust are removed by physical adsorption.

The present invention may be variously applied to fields such as smoke removal from subway stations, underground facilities, underground parking lots, various types of multi-use facilities, and various types of tunnels, removal of various types of industrial solid particulate-based ultra-fine dust, facilities for removing military gas, liquid particulate-based gas, solid particulate-based gas, various types of chemical substances, and toxic gas, commercial sterilization and disinfection facilities, hospitals, agricultural-livestock sterilization, defense equipment, and adsorption and removal of gaseous and liquid particulate-based offensive odor substances.

For convenience, in the present invention, the terms ‘smoke’ and ‘gas’ are used for the same object. The smoke and the gas have the same meaning.

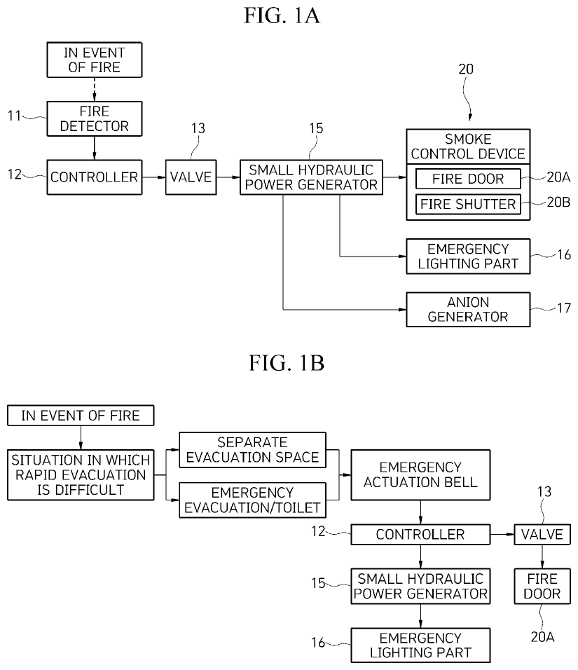

FIG. 1A is a block diagram illustrating an entire configuration of an in-building access path installation type smoke control system according to the present invention.

As illustrated, an entire structure of a smoke control system of the present invention includes a fire detector 11, a controller 12, a valve 13, a small hydraulic power generator 15, an emergency lighting part 16, an anion generator 17, and a smoke control device 20.

The fire detectors 11 are installed all over an interior of a building and detect a fire. In the event of a fire, the fire detector 11 transfers a detection result to the controller 12.

The controller 12 controls the valve 13 at the same time while notifying persons in the building of the occurrence of fire in various ways. That is, the valve 13 is opened so that firefighting water is supplied to the smoke control device 20.

The small hydraulic power generator 15 produces electric power while operating by receiving kinetic energy of firefighting water (hereinafter, referred to as ‘water’) that flows toward the smoke control device 20 via the valve 13. Even though a supply of electric power to the entire building is cut off by the fire, electric power may be produced as long as water is supplied.

The electric power produced by the small hydraulic power generator 15 is supplied to various electric power demanders, particularly, applied to the emergency lighting part 16 and the anion generator 17.

The emergency lighting part 16 is an LED lamp and emits light to the interior. A rescue requester may find an escape route while identifying the light from the emergency lighting part 16.

The anion generator 17 serves to trap and remove smoke, toxic gas, ultra-fine dust, soot, and the like that are positively charged and float. In other words, anions are coupled to positively charged fine particles and settled.

In addition, the smoke control device 20 includes a fire door 20A and a fire shutter 20B. The smoke control device 20 sucks fire heat, smoke, toxic gas, ultra-fine dust, soot, and the like which are concentrated in an upper layer of a location at which a fire occurs, and the smoke control device 20 mixes the fire heat, the smoke, the toxic gas, the ultra-fine dust, the soot, and the like with water, thereby reducing a concentration of the toxic substance and preventing physical deformation of or damage to the fire door and the fire shutter by cooling the fire door and the fire shutter.

FIG. 1B is a reference view for explaining an assumed situation in which the smoke control system according to the present embodiment is applied to an entrance or exit of a toilet in a building. The evacuation is enabled for almost one hour or more when the smoke control system of the present embodiment is applied to the toilet.

In a situation in which the persons cannot quickly escape to the outside of the building in the event of a fire in the building, the persons escape to a separate evacuation space or a toilet in the building. When the person evacuated to the toilet pushes an emergency actuation bell, the controller 12 operates, such that the smoke control operation is automatically performed according to the above-mentioned process. In this case, a ventilation fan in the toilet is switched to an air supply fan to supply oxygen from the outside. The toilet may be used as an emergency evacuation shelter. The reason why the toilet is determined as the separate evacuation space as described above is to ensure a large amount of golden time in a situation in which quick evacuation is difficult.

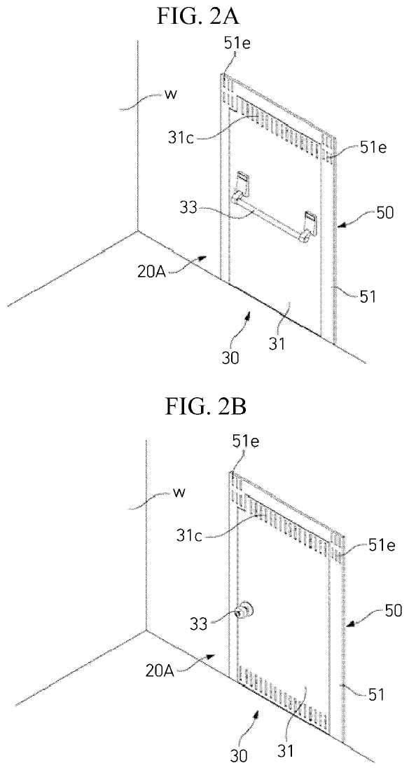

FIG. 2A is a perspective view illustrating an external configuration of the fire door 20A in the in-building access path installation type smoke control system according to the first embodiment of the present invention, and FIG. 2B is a perspective view illustrating an external configuration of the fire door 20A when the persons, who cannot escape to an emergency exit, use a particular space such as a toilet as an emergency evacuation shelter.

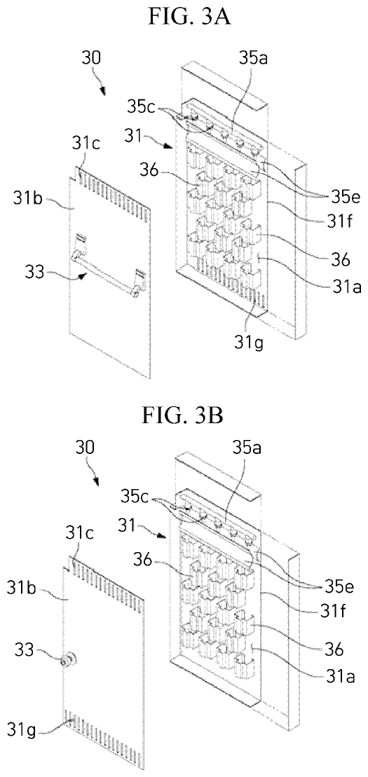

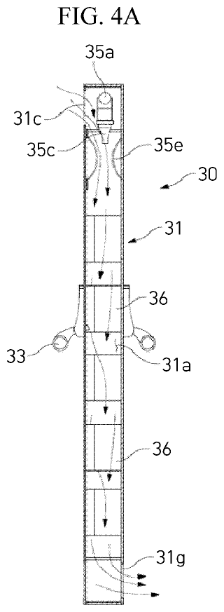

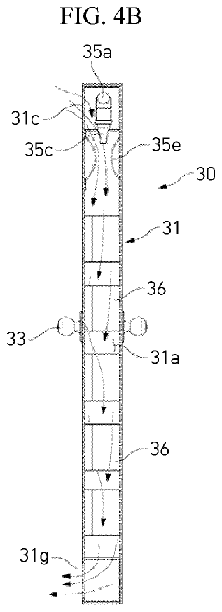

FIG. 3 is an exploded perspective view of a main door body 30 illustrated in FIG. 2, and FIG. 4 is a cross-sectional side view of the main door body.

As illustrated, the fire door 20A of the smoke control system 10 according to the first embodiment has the main door body 30 and a door frame 50. The main door body 30 is a so-called door opened or closed by a user. In addition, the door frame 50 is a door frame that supports the main door body 30 so that the main door body 30 is openable and closable.

The main door body 30 has a door casing 31, a door water supply pipe 35a, a door nozzle 35c, and negative pressure inducers 35e.

Like a general entrance/exit door, the door casing 31 has a quadrangular plate shape and a handle 33. The door casing 31 is manufactured by using an iron plate and has a negative pressure space 31a therein. The negative pressure space 31a is a space in which negative pressure generated by the negative pressure inducers 35e is maintained. The negative pressure space 31a is a mixing space in which smoke and water are mixed.

An intake port 31c is formed at an upper end of a front plate 31b of the door casing 31, and a discharge port 31g is provided at a lower end of a rear plate 31f. The intake port 31c is a passage that guides smoke, which is generated in the event of a fire, to the negative pressure space 31a. The discharge port 31g is a passage through which smoke, which is cooled in the negative pressure space 31a, and a mixture of water and smoke are discharged.

The front surface is a surface directed toward a space in which a fire occurs, and the rear surface is a space in which the fire is not spread.

Further, FIG. 3 illustrates that the intake port 31c is formed at the upper end of the front surface, and the discharge port 31g is positioned at the lower end of the rear surface. According to the embodiment, the intake port 31c may be applied to both the upper ends of the front and rear surfaces. Likewise, the discharge port 31g may be formed at both the lower ends of the front and rear surfaces.

The door water supply pipe 35a is a horizontal pipe that guides the water, which is supplied from the outside, into the door casing 31. The door water supply pipe 35a is positioned rearward of the intake port 31c. In addition, the door nozzle 35c serves to discharge, vertically downward, the water introduced through the door water supply pipe 35a. The number of applied door nozzles 35c may be changed.

The negative pressure inducers 35e are made by circularly bending two sheets of iron plates so that bent portions are disposed to face each other, such that a central portion of the negative pressure inducers 35e has a narrow shape. The water sprayed from the door nozzle 35c accelerates while passing through the negative pressure inducers 35e, thereby generating negative pressure on the basis of the Venturi effect. Because the Venturi effect is a general technology, a description thereof will be omitted.

The negative pressure generated by the negative pressure inducers 35e is applied to the outside of the door casing 31 and pulls ambient smoke. The smoke at the periphery of the fire door 20A is sucked into the door casing 31 through the intake port 31c. The sucked smoke moves downward while being kept mixed with the water and is discharged through the discharge port 31g.

That is, smoke or toxic gas dust, fine dust, soot, various types of non-combusted flammable gas, heat, and the like, which are produced in the event of a fire, are mixed with water in the door casing 31, liquid particulate-based toxic gas is removed by being dissolved and diluted in water, and solid particulate-based soot, ultra-fine dust, dust, and the like are removed by physical adsorption. For reference, hydrogen cyanide (HCN) and hydrogen fluoride (HF), which are water soluble toxic gas created in the event of a fire, are almost infinitely dissolved in water, hydrogen chloride (HCl) is dissolved in water significantly well, and phosgene (COCl₂), sulfur dioxide (SO₂), nitrogen dioxide (NO₂), carbon dioxide (CO₂), and the like are easily dissolved in water.

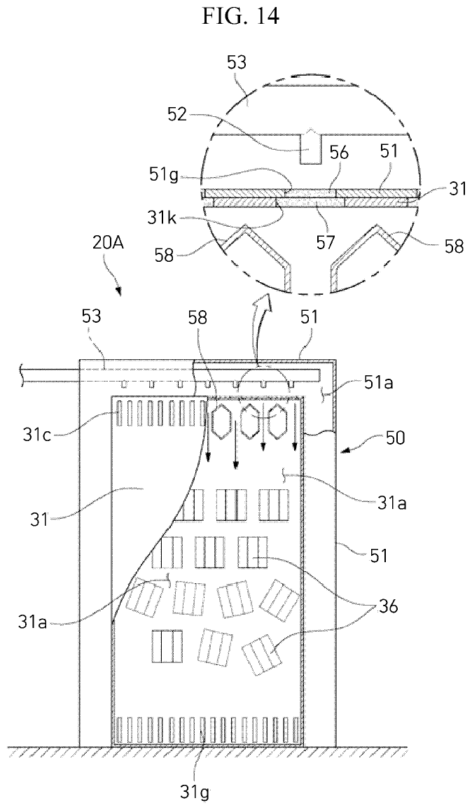

A plurality of mixing spacers 36 is installed below the negative pressure inducer 35e. The mixing spacer 36 serves to reinforce strength of the main door body 30. Further, the mixing spacer 36 more actively mixes the mixture of water and smoke while colliding with the mixture of water and smoke that moves downward, such that water and smoke are uniformly mixed. That is, the mixing spacer 36 effectively mixes toxic substances with water, such that the toxic substances are removed by physical adsorption, dilution, and dissolution. The number of mixing spacers 36 may be variously changed. As illustrated in FIG. 14, the mixing spacers 36 may be irregularly disposed.

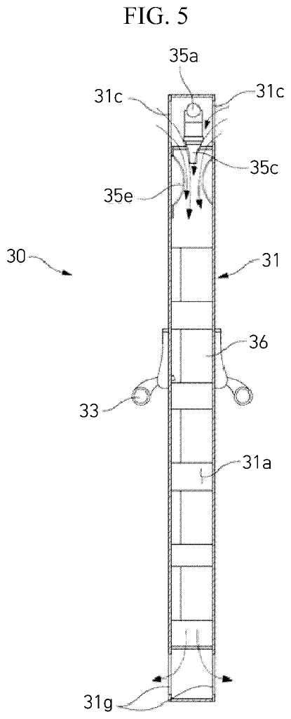

FIG. 5 is a cross-sectional side view illustrating a modified example of the main door body in FIG. 2.

Referring to FIG. 5, it can be seen that the intake ports 31c and the discharge ports 31g are formed in two opposite surfaces of the upper end and two opposite surfaces of the lower end of the door casing 31. Since intake and discharge cross-sectional flow areas are expanded, a larger amount of smoke may be treated.

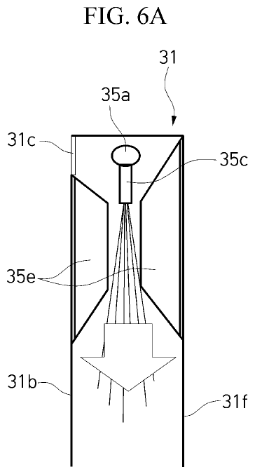

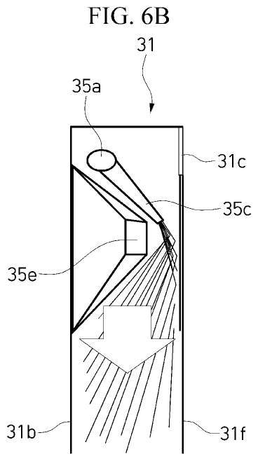

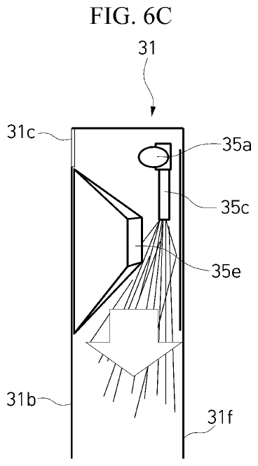

FIGS. 6 to 11 are side views schematically illustrating configurations of various negative pressure inducers 35e applicable to the main door body in FIG. 2.

The negative pressure inducers 35e illustrated in FIG. 6A have a trapezoidal cross-sectional shape and are fixed to an inner surface of the front plate 31b and an inner surface of the rear plate 31f. In addition, the door nozzle 35c is positioned above a space between the negative pressure inducers 35e.

The negative pressure inducer 35e illustrated in FIG. 6B is fixed to the inner surface of the front plate 31b. In addition, the door nozzle 35c sprays water in an oblique direction. The sprayed water is discharged downward while passing through a portion between the negative pressure inducer 35e and the rear plate 31f.

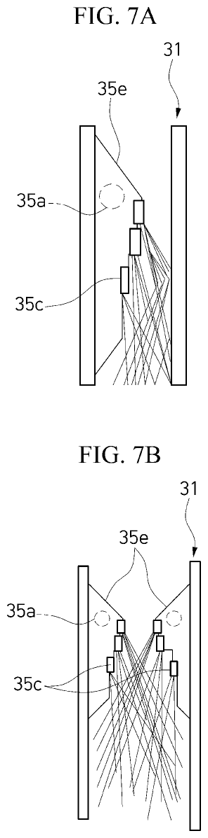

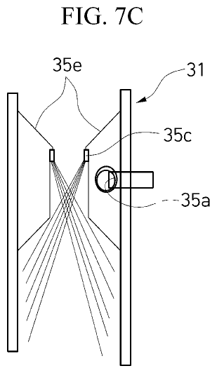

Like in FIG. 7, the negative pressure inducer 35e illustrated in FIG. 6C is fixed to the inner surface of the front plate 31b. In addition, the door nozzle 35c is disposed adjacent to the rear plate 31f and discharges water vertically downward.

FIGS. 7A to 7C are views illustrating the negative pressure inducers 35e having other structures.

The negative pressure inducers 35e illustrated in FIGS. 7A to 7C are each characterized in that the door water supply pipe 35a is coupled directly to the negative pressure inducer and the door nozzle 35c is installed on the negative pressure inducer 35e. The water supplied through the door water supply pipe 35a is stored in the negative pressure inducer 35e and then sprayed through the door nozzle 35c.

The water sprayed from the door nozzle 35c rapidly becomes moisture vapor by high-temperature heat of smoke and toxic gas. The water is vaporized and expanded in volume by about 1700 times or more at 100° C., 2400 times or more at 260° C., and 4200 times or more at 650° C. at 1 atm.

A flow velocity further increases when a volume of a fluid passing through an inside of a flow field is increased instantaneously. Therefore, a fluid with a high velocity, i.e., a fluid mixture, in which moisture vapor, gas, and water are complicatedly mixed, may further increase a suction force by rapidly decreasing internal pressure of the negative pressure space 31a on the basis of the Venturi effect. As a result, the fluid is sprayed at high speed in the negative pressure inducer 35e by vaporization and expansion of the fluid mixture (the fluid in which smoke and water are mixed), such that the suction force for sucking smoke and toxic gas is significantly increased.

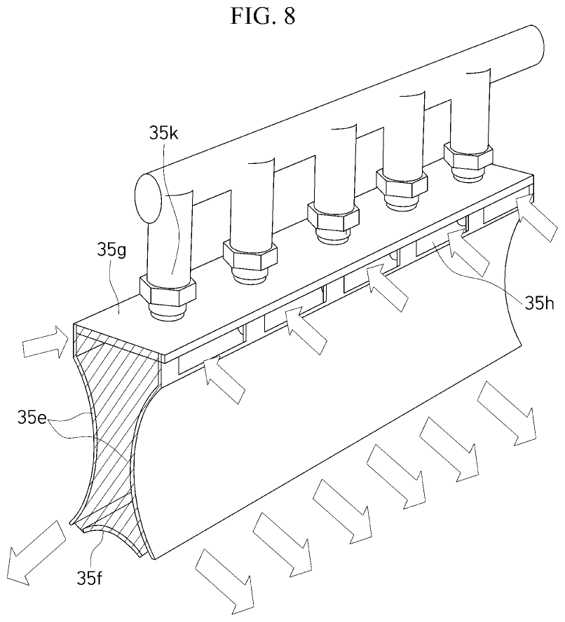

FIG. 8 is a view illustrating the negative pressure inducer 35e to which a reflector 35f and a support plate 35g are applied. The reflector 35f is a member installed on a lower portion of the negative pressure inducer 35e and collides with the mixture of water and smoke passing through the negative pressure inducer 35e. After the water and smoke collide with the reflector 35f, the water and smoke accelerate once again while being discharged to two opposite ends of the reflector 35f based on a width direction of the reflector 35f. The acceleration means that the negative pressure is generated.

The support plate 35g is a plate-shaped member having a plurality of nozzle installation port 35k. The door nozzle is mounted in the nozzle installation port 35k. Further, intake ports 35h are provided at a lower side of the support plate 35g based on the width direction. The intake port 35h is a passage through which smoke pulled by negative pressure is sucked.

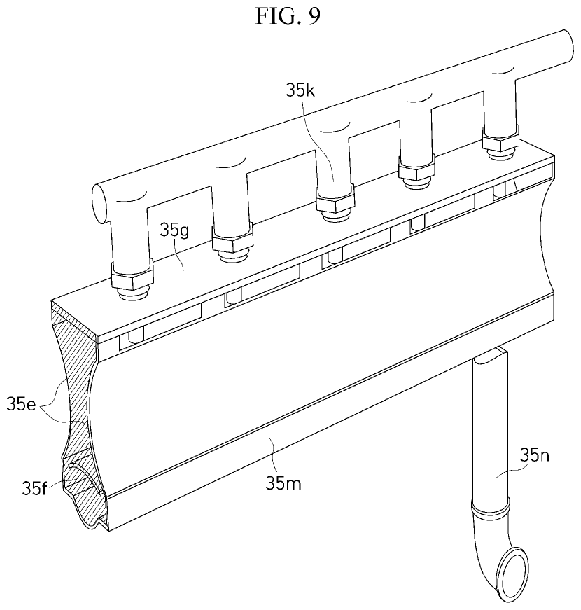

In addition, as illustrated in FIG. 9, a gutter 35m may be further installed at a lower side of the negative pressure inducer 35e. The gutter 35m is a water receptacle that receives water passing through the negative pressure inducer 35e and guides the water to a vertical pipe 35n. The vertical pipe 35n is a pipe that guides vertically downward the water mixed with the smoke and discharges the water mixed with the smoke to the outside.

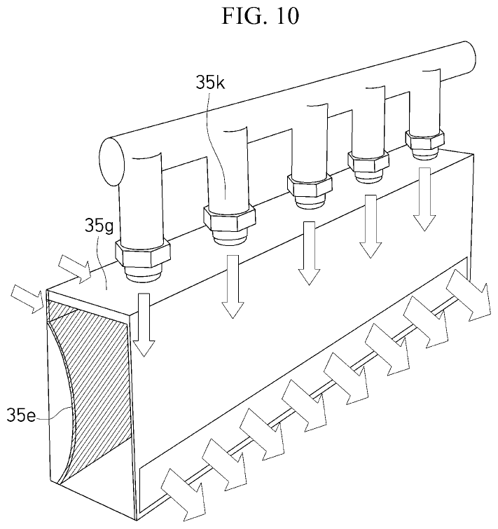

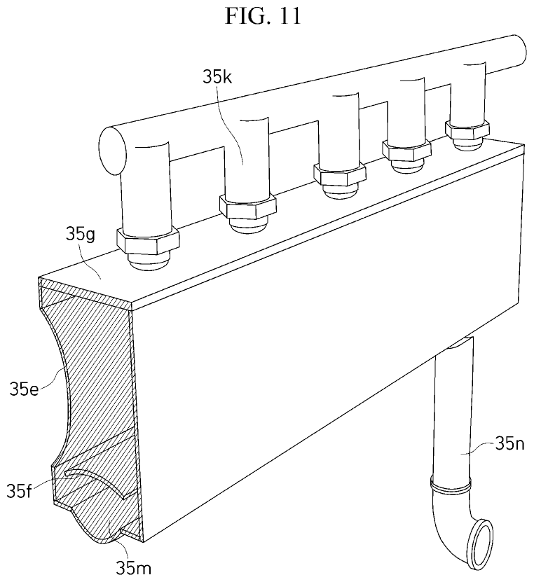

Further, as illustrated in FIG. 10, only the single negative pressure inducer 35e may be applied. This configuration has been described with reference to FIGS. 6B and 6C. FIG. 11 is a view illustrating a state in which the gutter 35m and the vertical pipe 35n are installed at the lower side of the negative pressure inducer 35e illustrated in FIG. 10.

Meanwhile, the door frame 50 is fixed to the in-building access path and supports an entrance/exit door so that the entrance/exit door is openable and closable. The entrance/exit door may be a general fire door or the main door body 30 of a type illustrated in FIG. 3.

Like the main door body 30, the door frame 50 included in the smoke control device 20 of the first embodiment has smoke control and cooling abilities.

The door frame 50 has a frame casing 51, a frame pipe 53, a frame nozzle 52, and a negative pressure inducer 55.

The frame casing 51 is a so-called door frame having a quadrangular shape. The entrance/exit door or the main door body 30 is openably and closably installed in the frame casing 51.

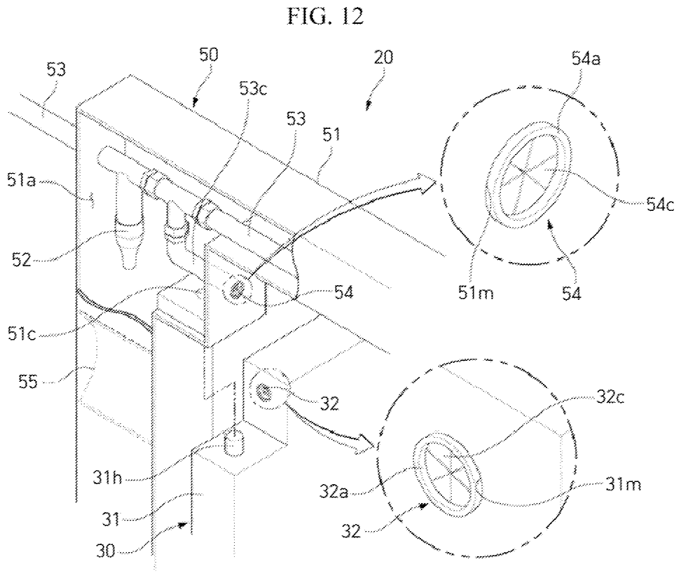

The frame casing 51 is manufactured by using an iron plate. As illustrated in FIG. 12, the frame casing 51 has a negative pressure space 51a. The negative pressure space 51a is a space in which negative pressure generated by the negative pressure inducer 55 is maintained. In addition, an intake port 51e is formed at an upper end of a front surface of the frame casing 51. The intake port 51e is a passage through which ambient smoke flows into the negative pressure space 51a. Further, a discharge port (not illustrated) is formed at a lower end of a rear surface of the frame casing 51. The discharge port is a passage through which the mixture of water and smoke is discharged.

The frame pipe 53 is a pipe that guides water, which is supplied from the outside, into the frame casing 51, and the frame pipe 53 is connected to the frame nozzle 52. The water supplied through the frame pipe 53 is discharged downward through the frame nozzle 52.

The negative pressure inducer 55 generates negative pressure on the basis of the Venturi effect while allowing water sprayed through the frame nozzle 52 to pass therethrough. The negative pressure generated by the negative pressure inducer 55 is applied to the outside of the frame casing 51 and pulls the smoke at the periphery of the intake port 51e into the negative pressure space 51a.

The smoke introduced into the frame casing 51 is discharged to the outside after being removed by the process similar to the process performed in the main door body 30.

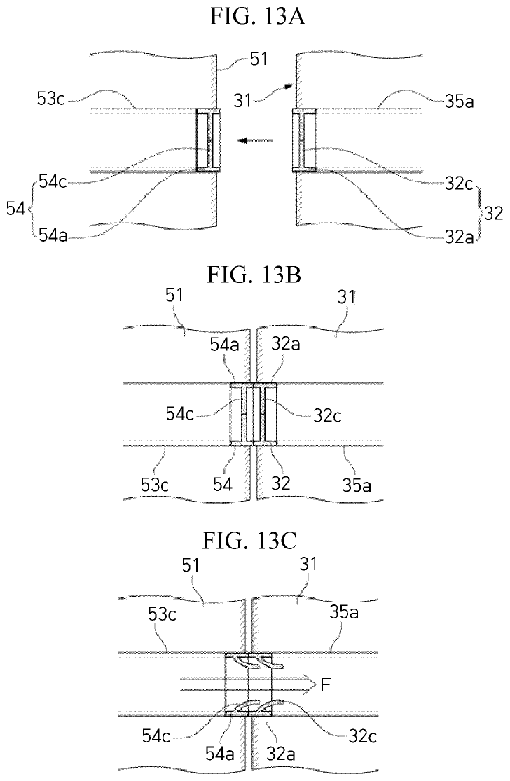

FIG. 12 is a view illustrating a modified example of the fire door 20A included in the in-building access path installation type smoke control system according to the first embodiment of the present invention. FIGS. 13A to 13C is a view for explaining operations of a stationary sealing seal and a movable sealing seal illustrated in FIG. 12.

The fire door 20A in FIG. 12 is characterized in that the main door body 30 and the door frame 50 are combined. That is, the main door body 30 having the smoke control ability is coupled to the door frame 50 having the smoke control ability.

Hereinafter, the reference numerals identical to the above-mentioned reference numerals indicate the same members having the same functions.

As illustrated, support shafts 31h are provided on the door casing 31. Shaft insertion holes 51c are provided in the frame casing 51, and the support shafts 31h are fitted into the shaft insertion holes 51c.

The support shafts 31h serve as rotation axes of the main door body 30 and are positioned at upper and lower ends of the door casing 31. FIG. 12 illustrates only the support shaft 31h at the upper end. Of course, the support shafts at the upper and lower ends are positioned on the same central axis. The shaft insertion hole 51c is a hole that accommodates the support shaft 31h. As the support shafts 31h are fitted into the shaft insertion hole 51c, the main door body 30 may rotate.

In addition, a branch pipe 53c is installed in the frame casing 51. The branch pipe 53c is a pipe connected to the frame pipe 53 and has a second sealing seal 54 provided at an end thereof. The branch pipe 53c is a guide pipe that guides a part of water, which is supplied through the frame pipe 53, to the door water supply pipe 35a.

Meanwhile, a first sealing seal 32 and the second sealing seal 54 are provided on the main door body 30 and the door frame 50. The first sealing seal 32 and the second sealing seal 54 operate in conjunction with each other in the state in which the main door body is closed, thereby providing a route through which the water in the branch pipe 53c may flow to the door water supply pipe 35a.

The first and second sealing seals 32 and 54 are elastic members made of heat resistive rubber and have the same shape. The first sealing seal 32 is fixed to an end of the door water supply pipe 35a. In addition, the second sealing seal 54 is fixed to an end of the branch pipe 53c.

The first sealing seal 32 has a fixing ring 32a and elastic blocking pieces 32c. The fixing ring 32a is a ring-shaped member having a predetermined diameter and fitted into a first seal installation hole 31m of the door casing 31. The first seal installation hole 31m is a through-hole in which the fixing ring 32a is installed.

The elastic blocking pieces 32c are integrated with an inner peripheral surface of the fixing ring and are on standby in a closed state at ordinary times. When hydraulic pressure is applied, the elastic blocking pieces 32c are spread and opened by hydraulic pressure, as illustrated in FIG. 13C. Because the door water supply pipe 35a is closed by the first sealing seal 32, outside foreign substances cannot enter the door water supply pipe 35a.

The second sealing seal 54 has a fixing ring 54a having a predetermined diameter, and elastic blocking pieces 54c. The fixing ring 54a is detachably fitted into a second seal installation hole 51m formed in the frame casing 51. The second seal installation hole 51m is a through-hole in which the fixing ring 54a is installed.

In addition, the elastic blocking pieces 54c are integrated with an inner peripheral surface of the fixing ring 54a and are on standby in a closed state at ordinary times. When hydraulic pressure is applied, the elastic blocking pieces 54c are spread and opened by hydraulic pressure, as illustrated in FIG. 13C. The branch pipe 53c is closed by the second sealing seal 54, such that outside foreign substances cannot enter the branch pipe 53c.

FIG. 13A illustrates a state in which the main door body 30 is opened, and the first sealing seal 32 and the second sealing seal 54 are spaced apart from each other. The first sealing seal 32 seals and protects the door water supply pipe 35a, and the second sealing seal 54 seals and protects the branch pipe 53c.

When the main door body 30 is closed in this state, the first sealing seal 32 moves toward the second sealing seal 54, and the first sealing seal 32 and the second sealing seal 54 come into close contact with each other, as illustrated in FIG. 13B. The fixing ring 32a of the first sealing seal and the fixing ring 54a of the second sealing seal constitute a single conduit by coming into close contact with each other.

When a fire occurs and water is supplied in this state, a part of the water flows in a direction indicated by the arrow F, pushes and opens the elastic blocking pieces 32c and 54c, and then moves to the door water supply pipe 35a. The elastic blocking pieces 32c and 54c are spread by hydraulic pressure. The elastic blocking pieces 32c and 54c have elastic restoration properties, such that the elastic blocking pieces 32c and 54c are restored to initial positions when hydraulic pressure is eliminated.

FIG. 14 is a view illustrating another modified example of the fire door 20A of the in-building access path installation type smoke control system according to the first embodiment of the present invention.

The fire door 20A illustrated in FIG. 14 includes the main door body 30 configured to be openable and closable, and the door frame 50 configured to support the main door body.

As described above, the main door body 30 has the door casing 31 and negative pressure inducers 58. Of course, the intake port 31c and the discharge port 31g are formed at upper and lower ends of the front and rear surfaces of the door casing 31.

In particular, a plurality of through receiving holes 31k provided at an upper end of the door casing 31 and disposed at predetermined intervals. The receiving hole 31k is a through-hole that allows water sprayed from the frame nozzle 52 to pass downward therethrough, and the receiving hole 31k is closed by a sealing cap 57. The sealing cap 57 is separated from the receiving hole 31k by receiving pressure of water sprayed from the frame nozzle 52.

The negative pressure inducer 58 is a member having an approximately hexagonal shape. The negative pressure inducers 58 are disposed at left and right sides below the receiving holes 31k. The discharged water passing through the receiving holes 31k passes through a portion between the negative pressure inducers 58. Of course, negative pressure is generated on the basis of the Venturi effect while the discharged water passes through the negative pressure inducers 58.

The plurality of mixing spacers 36 are irregularly fixed below the negative pressure inducers 58. The mixing spacer 36 has been described above.

In addition, the frame pipe 53 is horizontally disposed at an upper side in the door frame 50, and the plurality of frame nozzles 52 is provided on the frame pipe 53. The frame nozzle 52 serves to spray downward water supplied through the frame pipe 53.

Further, a plurality of discharge passages 51g is formed in the door frame 50. The discharge passage 51g is a through-hole disposed above the receiving hole 31k while corresponding to the receiving hole 31k. The discharge passage 51g is closed by the sealing cap 56. An inner diameter of the discharge passage 51g is relatively smaller than an inner diameter of the receiving hole 31k. The sealing cap 56 is separated from the discharge passage 51g by pressure of the discharged water sprayed from the frame nozzle 52 and then falls downward together with another sealing cap 57.

In the fire door 20A having the above-mentioned configuration, when water is supplied through the frame pipe 53, the water passes through the discharge passage 51g and the receiving hole 31k and then generates negative pressure while passing through the portion between the negative pressure inducers 58 in the door casing 31.

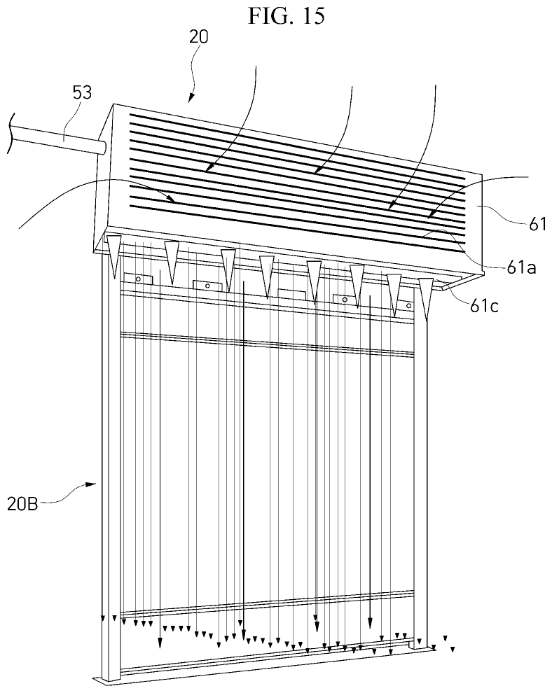

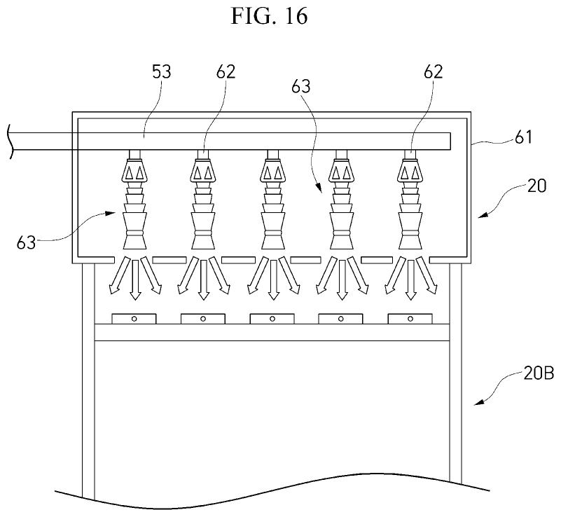

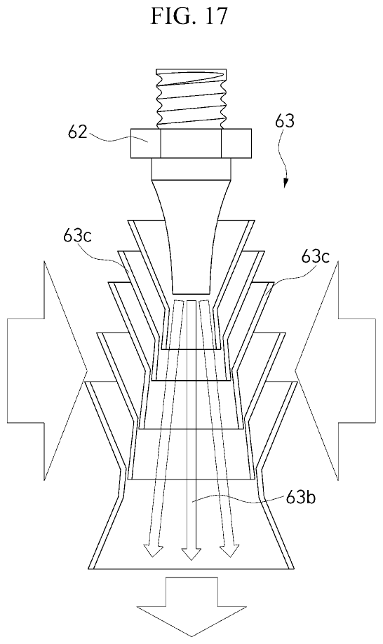

FIG. 15 is a perspective view illustrating an external appearance of an in-building access path installation type smoke control system according to a second embodiment of the present invention, and FIG. 16 is a view schematically illustrating an internal configuration of a casing illustrated in FIG. 15. In addition, FIG. 17 is a cross-sectional view illustrating an internal structure of a multistage negative pressure inducer in FIG. 16.

A smoke control device 20 of a smoke control system 10 according to the second embodiment is installed at an upper side of the fire shutter 20B.

As publicly known, the fire shutter is installed in an inevitable case in which wall bodies having refractory structures or various types of fire doors cannot be installed on fireproof partition lines. The fire shutter autonomously has an opening/closing device (not illustrated) capable of electrically or manually opening or closing the fire shutter, and a detector such as a smoke detector.

The smoke control device 20 includes a mixing housing 61, the frame pipe 53, the plurality of nozzles 52, and a negative pressure inducer 63.

The mixing housing 61 has an approximately hexahedral shape and includes intake ports 61a formed in a front surface thereof, and discharge ports 61c formed in a bottom surface thereof. The intake port 61a is a passage through which outside smoke flows into the mixing housing 61 when negative pressure is generated by the negative pressure inducer 63.

In addition, the discharge port 61c is a hole through which water mixed with smoke is discharged downward. The discharge port 61c is positioned to be maximally adjacent to the fire shutter 20B so that the fire shutter 20B is cooled by water.

The negative pressure inducer 63 serves to discharge water discharged from the nozzle 62 while allowing the water to pass therethrough and has an internal configuration illustrated in FIG. 17.

As illustrated in FIG. 17, a spray passage 63b and a plurality of intake passages 63c are formed in the negative pressure inducer 63. The spray passage 63b is a rectilinear passage having an inner diameter that increases in a flow direction of water. In addition, the intake passage 63c is a hole that is opened in a lateral direction of the spray passage and allows negative pressure generated in the spray passage to be applied to the outside.

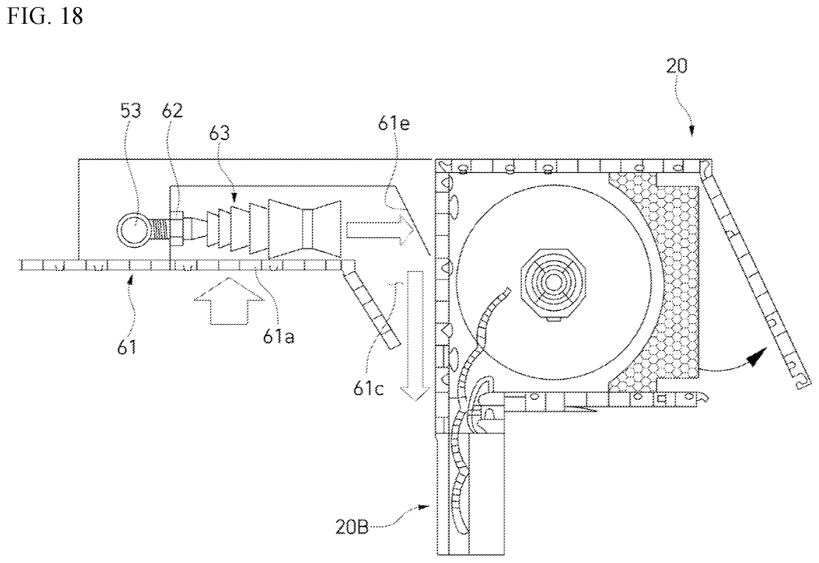

FIG. 18 is a view illustrating a modified example of the in-building access path installation type smoke control system according to the second embodiment of the present invention.

As illustrated, the negative pressure inducer 63 is horizontally installed, and the intake port 61a is formed in the bottom surface of the mixing housing 61. In addition, the discharge port 61c is inclined and opened to the fire shutter 20B.

When water is supplied through the frame pipe 53, the water passes through the nozzle 62 and the negative pressure inducer 63, collides with a guide inclined surface 61e, and then flows downward along the fire shutter 20B. At the same time, outside smoke passes upward through the intake port 61a, flows into the negative pressure inducer 63, and then is mixed with water.

While the present invention has been described above in detail with reference to the specific embodiments, the present invention is not limited to the embodiments but may be variously modified by those skilled in the art without departing from the technical spirit of the present invention.

1. An in-building access path installation type smoke control system, which is openably and closably installed in an in-building access path, the in-building access path installation type smoke control system comprising:
a door casing having an intake port and a discharge port;
a door nozzle installed in the door casing and configured to spray water supplied from the outside; and
a main door body including a negative pressure inducer configured to allow water sprayed from the door nozzle to pass therethrough, generate negative pressure on the basis of the Venturi effect while the water passes therethrough, suck gas at the periphery of the door casing through the intake port, mix the sucked gas with water, and move the gas mixed with the water downward toward the discharge port.

2. An in-building access path installation type smoke control system, which is fixed in an in-building access path and supports an entrance/exit door so that the entrance/exit door is openable and closable, the in-building access path installation type smoke control system comprising:
a frame casing having an intake port and a discharge port;
a frame nozzle installed in the frame casing and configured to spray water supplied from the outside; and
a door frame having a negative pressure inducer configured to allow water sprayed from the frame nozzle to pass therethrough, generate negative pressure on the basis of the Venturi effect while the water passes therethrough, suck gas at the periphery of the frame casing through the intake port, mix the sucked gas with water, and move the gas mixed with the water downward toward the discharge port.

3. The in-building access path installation type smoke control system of claim 2, wherein the entrance/exit door comprises:
a door casing having an intake port and a discharge port;
a door nozzle embedded in the door casing and configured to spray water supplied from the outside; and
a main door body having a Venturi body configured to allow water sprayed from the door nozzle to pass therethrough, generate negative pressure on the basis of the Venturi effect while the water passes therethrough, suck gas at the periphery of the door casing through the intake port, mix the sucked gas with water, and move the gas mixed with the water downward toward the discharge port.

4. The in-building access path installation type smoke control system of claim 3, wherein the main door body and the door frame have a first sealing seal and a second sealing seal that operate in conjunction with each other, in a state in which the main door body is closed, to provide a route through which the water is supplied to the door nozzle.

5. The in-building access path installation type smoke control system of claim 4, wherein the door casing and the frame casing respectively have first and second installation holes in which the first and second sealing seals are installed,
wherein the first sealing seal comprises:
a fixing ring having a ring shape and fitted into the first seal installation hole; and
elastic blocking pieces integrated with an inner peripheral surface of the fixing ring and configured to be on standby in a closed state at ordinary times and spread and opened by hydraulic pressure when the hydraulic pressure is applied, and
wherein the second sealing seal comprises:
a fixing ring having a ring shape and fitted into the second seal installation hole; and
elastic blocking pieces integrated with an inner peripheral surface of the fixing ring and configured to be on standby in a closed state at ordinary times and spread and opened by hydraulic pressure when the hydraulic pressure is applied.

6. An in-building access path installation type smoke control system comprising:
a main door body including a door casing having an intake port and a discharge port and having a plurality of through receiving holes provided at an upper end thereof, and a negative pressure inducer installed in the door casing and configured to allow water discharged downward through the receiving hole to pass therethrough, generate negative pressure on the basis of the Venturi effect, suck gas at the periphery of the door casing through the intake port, mix the sucked gas with water, and guide the gas mixed with the water to the discharge port; and
a door frame configured to support the main door body so that the main door body is openable and closable, the door frame including a frame casing having an intake port and a discharge port and having a discharge passage corresponding to the receiving hole in a one-to-one manner in a state in which the main door body is closed, and a nozzle installed in the frame casing and configured to spray water, which is supplied from the outside, to the discharge passage so that the water passes through the negative pressure inducer via the receiving hole.

7. The in-building access path installation type smoke control system of claim 6, wherein sealing caps are respectively mounted in the receiving hole and the discharge passage and separated and removed by receiving pressure of the water when the water is sprayed.

8. An in-building access path installation type smoke control system comprising:
a mixing housing installed at an upper side of a fire shutter in an in-building access path and having an intake port and a discharge port;
a plurality of nozzles embedded in the mixing housing and configured to spray water supplied from the outside; and
a negative pressure inducer installed below the nozzle and configured to allow water sprayed from the nozzle to pass therethrough, generate negative pressure on the basis of the Venturi effect while the water passes therethrough, suck gas at the periphery of the mixing housing through the intake port, mix the sucked gas with water, and discharge the gas mixed with the water.

9. The in-building access path installation type smoke control system of claim 8, wherein the negative pressure inducer comprises:
a spray passage having an inner diameter that increases in a flow direction of water; and
a plurality of intake passages opened in a lateral direction of the spray passage and allow the negative pressure generated in the spray passage to be applied to the outside.

10. The in-building access path installation type smoke control system of claim 1, further comprising:
a mixing spacer installed in the door casing and configured to mix water with gas while colliding with the sprayed water.

11. The in-building access path installation type smoke control system of claim 1, further comprising:
a small hydraulic power generator configured to produce electric power by receiving kinetic energy of water supplied in the event of a fire;
an emergency lighting part configured to operate by receiving electric power of the small hydraulic power generator; and
an anion generator configured to trap and remove positively charged particles in the gas by outputting anions.

12. The in-building access path installation type smoke control system of claim 2, further comprising:
a mixing spacer installed in the door casing and configured to mix water with gas while colliding with the sprayed water.

13. The in-building access path installation type smoke control system of claim 6, further comprising:
a mixing spacer installed in the door casing and configured to mix water with gas while colliding with the sprayed water.

14. The in-building access path installation type smoke control system of claim 8, further comprising:
a mixing spacer installed in the door casing and configured to mix water with gas while colliding with the sprayed water.

15. The in-building access path installation type smoke control system of claim 2, further comprising:
a small hydraulic power generator configured to produce electric power by receiving kinetic energy of water supplied in the event of a fire;
an emergency lighting part configured to operate by receiving electric power of the small hydraulic power generator; and
an anion generator configured to trap and remove positively charged particles in the gas by outputting anions.

16. The in-building access path installation type smoke control system of claim 6, further comprising:
a small hydraulic power generator configured to produce electric power by receiving kinetic energy of water supplied in the event of a fire;
an emergency lighting part configured to operate by receiving electric power of the small hydraulic power generator; and
an anion generator configured to trap and remove positively charged particles in the gas by outputting anions.

17. The in-building access path installation type smoke control system of claim 8, further comprising:
a small hydraulic power generator configured to produce electric power by receiving kinetic energy of water supplied in the event of a fire;
an emergency lighting part configured to operate by receiving electric power of the small hydraulic power generator; and
an anion generator configured to trap and remove positively charged particles in the gas by outputting anions.
